(19) United States
(12) Patent Application Publication
(10) Pub. No.: US 2026/0340886 A1
(43) Pub. Date: Oct. 29, 2026

(54) METHOD, DEVICE AND STORAGE MEDIUM FOR INFORMATION PROCESSING

(71) Applicant: Beijing Zitiao Network Technology Co., Ltd., Beijing (CN)

(72) Inventors: Zeyue XUE, Beijing (CN); Jie WU, Beijing (CN); Weilin HUANG, Beijing (CN)

(21) Appl. No.: 19/662,587

(22) Filed: Apr. 29, 2026

(30) Foreign Application Priority Data
Apr. 29, 2025 (CN) 202510561034.6

(51) Int. Cl. G06T 11/00; G06T 7/00; G06T 7/20; G06V 10/74

(52) U.S. Cl. CPC G06T 11/00; G06T 7/0002; G06T 7/20; G06V 10/74; G06T 2207/10016; G06T 2207/30168

(57) ABSTRACT

Embodiments of the disclosure relate to a method, apparatus, device, and computer-readable storage medium for information processing. The method proposed herein includes: obtaining a set of visual content generated by a visual generation model based on input information; determining reward information corresponding to respective pieces of visual content in the set of visual content; determining advantage information of the respective pieces of visual content in the set of visual content based on the reward information corresponding to the respective pieces of visual content; and adjusting the visual generation model at least based on a set of advantage information corresponding to the set of visual content. In this way, the embodiments of the disclosure may improve the quality of visual content generation.

### CROSS-REFERENCE

The present application claims priority to Chinse patent application No. 202510561034.6, filed on Apr. 29, 2025, entitled “Method, Apparatus, Device, and Storage Medium for Information Processing”, the disclosures of which are incorporated herein by reference in their entireties.

### FIELD

Example embodiments of the present disclosure generally relate to the field of computers, and in particular, to a method, apparatus, device, and computer-readable storage medium for information processing.

### BACKGROUND

With the development of computer technology, generative models are gradually applied to the processing of various tasks. For example, some generative models may generate video content based on input prompt information. However, some generative models are limited in terms of performance and scalability, and thus the generated video content does not meet expectations.

### SUMMARY

In a first aspect of the present disclosure, a method of information processing is provided. The method includes: obtaining a set of visual content generated by a visual generation model based on input information; determining reward information corresponding to respective pieces of visual content in the set of visual content; determining advantage information of the respective pieces of visual content in the set of visual content based on the reward information corresponding to the respective pieces of visual content; and adjusting the visual generation model at least based on a set of advantage information corresponding to the set of visual content.

In a second aspect of the present disclosure, an apparatus for information processing is provided. The apparatus includes: an obtaining module configured to obtain a set of visual content generated by a visual generation model based on input information; a first determination module configured to determine reward information corresponding to respective pieces of visual content in the set of visual content; a second determination module configured to determine advantage information of the respective pieces of visual content in the set of visual content based on the reward information corresponding to the respective pieces of visual content; and an adjustment module configured to adjust the visual generation model at least based on a set of advantage information corresponding to the set of visual content.

In a third aspect of the present disclosure, an electronic device is provided. The device includes at least one processor; and at least one memory coupled to the at least one processor and storing instructions executable by the at least one processor, the instructions, when executed by the at least one processor, causing the device to perform the method of the first aspect.

In a fourth aspect of the present disclosure, a computer-readable storage medium is provided. The computer-readable storage medium stores a computer program executable by a processor to implement the method of the first aspect.

It should be understood that the content described in this Summary section is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The foregoing and other features, advantages, and aspects of the embodiments of the present disclosure become more apparent with reference to the following detailed description and in conjunction with the drawings. In the drawings, the same or similar reference numerals denote the same or similar elements.

FIG. 1 illustrates a schematic diagram of an example environment in which the embodiments of the present disclosure may be implemented;

FIG. 2 illustrates a first flowchart of an example process of information processing according to some embodiments of the present disclosure;

FIG. 3 illustrates a second flowchart of an example process of information processing according to some embodiments of the present disclosure;

FIG. 4 illustrates a schematic structural block diagram of an example apparatus for information processing according to some embodiments of the present disclosure; and

FIG. 5 illustrates a block diagram of an electronic device capable of implementing a plurality of embodiments of the present disclosure.

### DETAILED DESCRIPTION

The embodiments of the present disclosure are described in more detail below with reference to the drawings. Although some embodiments of the present disclosure are shown in the drawings, it should be understood that the present disclosure may be implemented in various forms and should not be construed as being limited to the embodiments set forth herein. On the contrary, these embodiments are provided for a more thorough and complete understanding of the present disclosure. It should be understood that the drawings and the embodiments of the present disclosure are only for purposes of example, and are not intended to limit the protection scope of the present disclosure.

It should be noted that the titles of any sections/subsections provided herein are not restrictive. Various embodiments are described throughout the specification, and any type of embodiments may be included under any section/subsection. In addition, the embodiments described in any section/subsection may be combined with any other embodiments described in the same section/subsection and/or different sections/subsections in any manner.

In the description of the embodiments of the present disclosure, the term “include/comprise” and similar terms thereof should be understood as open-ended inclusions, that is, “include/comprise but not limited to”. The term “based on” should be understood as “at least partially based on”. The term “one embodiment” or “the embodiment” should be understood as “at least one embodiment”. The term “some embodiments” should be understood as “at least some embodiments”. Other explicit and implicit definitions may also be included below. The terms “first”, “second”, and the like may refer to different or same objects. Other explicit and implicit definitions may also be included below.

The embodiments of the present disclosure may involve user data, data acquisition, and/or data use. These aspects all comply with the corresponding laws, regulations, and related provisions. In the embodiments of the present disclosure, all data collection, acquisition, processing, forwarding, and use are performed on the premise that the user is aware and confirms. Accordingly, when implementing the embodiments of the present disclosure, the user should be informed of and authorize the type, use range, use scenarios, etc., of data or information possibly involved in an appropriate manner according to relevant laws and regulations. The specific manner of informing and/or authorizing may vary according to the actual situation and application scenarios, and the scope of the present disclosure is not limited in this regard.

If personal information processing is involved in the solutions in the specification and the embodiments, the processing is performed on the premise that there is a legal basis (for example, the consent of the personal information subject is obtained, or it is necessary for the performance of a contract, etc.), and the processing is only performed within the scope of provisions or agreements. If the user refuses to process personal information other than necessary information required for basic functions, it does not affect the user to use of the basic functions.

Currently, image generation is generally performed using a diffusion model or a correction flow, but both the diffusion model and the correction flow have the problem of low video memory utilization efficiency, and it is difficult to scale them up to large-scale tasks. In addition, due to the formal contradiction between the sampling mechanism of the correction flow and the Markov decision process, it is difficult to directly apply a reinforcement learning policy, which makes the output of the model not meet expectations.

An embodiment of the present disclosure provides a solution of information processing. The solution includes: obtaining a set of visual content generated by a visual generation model based on input information; determining reward information corresponding to respective pieces of visual content in the set of visual content; determining advantage information of the respective pieces of visual content in the set of visual content based on the reward information corresponding to the respective pieces of visual content; and adjusting the visual generation model at least based on a set of advantage information corresponding to the set of visual content. The embodiments of the present disclosure apply group relative policy optimization to the visual generation model, so that the visual generation model improves the quality of output content through reinforcement learning.

Various example implementations of the solution are described in detail below with further reference to the drawings.

### Example Environment

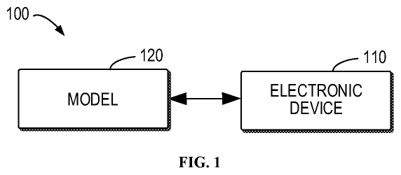

FIG. 1 illustrates a schematic diagram of an example environment 100 in which the embodiments of the present disclosure may be implemented. As shown in FIG. 1, the example environment 100 may include an electronic device 110. In some embodiments, the electronic device 110 may perform the following operations: obtaining a set of visual content generated by a visual generation model 120 based on input information; determining reward information corresponding to respective pieces of visual content in the set of visual content; determining advantage information of the respective pieces of visual content in the set of visual content based on the reward information corresponding to the respective pieces of visual content; and adjusting the visual generation model 120 at least based on a set of advantage information corresponding to the set of visual content. The visual generation model 120 may be deployed on the electronic device 110 or on another device, which is not described in detail herein.

In some embodiments, the electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/video camera, a positioning device, a television receiver, a radio broadcast receiver, an e-book device, a game device, or any combination thereof, including the accessories and peripherals of these devices, or any combination thereof. In some embodiments, the electronic device 110 may also support any type of interface for a target user (such as “wearable” circuitry, etc.).

The electronic device 110 may also be an independent physical server, a server cluster or distributed system composed of a plurality of physical servers, or a cloud server that provides basic cloud computing services such as cloud services, cloud databases, cloud computing, cloud functions, cloud storage, network services, cloud communications, middleware services, domain name services, security services, content delivery networks, and big data and artificial intelligence platforms. The electronic device 110 may include, for example, a computing system/server, such as a mainframe, an edge computing node, a computing device in a cloud environment, and the like.

It should be understood that the structure and functions of the embedded elements in the environment 100 are described for illustrative purposes only, without suggesting any limitations on the scope of the present disclosure.

Some example embodiments of the present disclosure are described below with continued reference to the drawings.

### Example Process

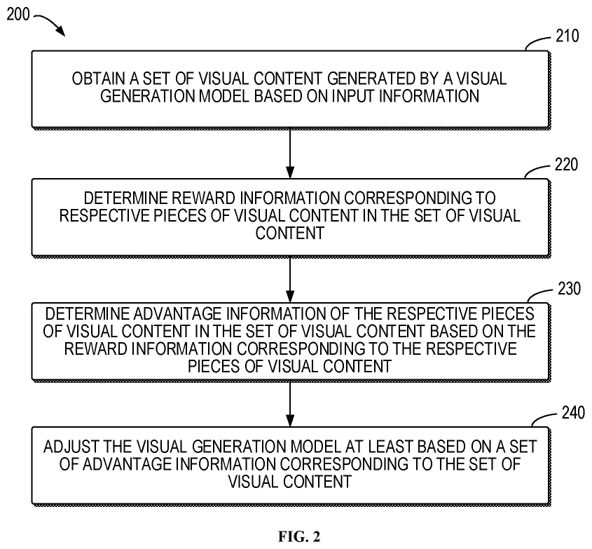

FIG. 2 illustrates a flowchart of an example process 200 of information processing according to some embodiments of the present disclosure. The process 200 may be implemented at the electronic device 110.

As shown in FIG. 2, at block 210, the electronic device 110 may obtain a set of visual content generated by a visual generation model based on input information.

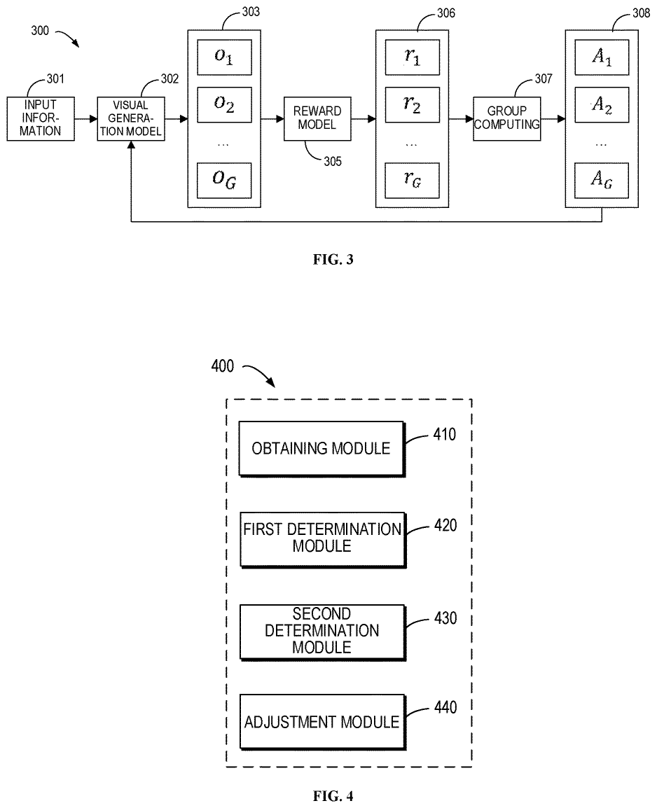

An information processing process according to some embodiments of the present disclosure is described below with reference to FIG. 3. As shown in FIG. 3, input information 301 may be provided to a visual generation model 302.

As an example, the input information 301 may be the text prompt information “A cat sitting on a sofa”, and the text prompt information is used to guide the visual generation model to generate corresponding visual content. Due to the generating randomness of the visual generation model 302, the visual generation model 302 may generate a set of different visual content 303 {o₁, o₂, . . . , o_{G}} based on the input information 301. For example, the set of visual content 303 may include a plurality of different videos corresponding to “A cat sitting on a sofa”.

As shown in FIG. 2, at block 220, the electronic device 110 may determine reward information corresponding to respective pieces of visual content in the set of visual content.

Continuing to refer to FIG. 3, a reward model 305 may process the generated set of visual content 303 to generate reward information 306 for the respective pieces of visual content 303. As shown in the figure, the reward model 305 may determine a set of reward information {r₁, r₂, . . . , r_{G}} corresponding to the set of visual content {o₁, o₂, . . . , o_{G}}, respectively.

In some embodiments, group relative policy optimization (GRPO) is a policy gradient-based reinforcement learning optimization algorithm, which aims to improve the stability and efficiency of policy updates through group relative comparison. The core idea is to group generated samples by quality and optimize the model through inter-group comparative learning, rather than relying on absolute reward values. Therefore, the embodiments of the present disclosure apply the group relative policy optimization method to the visual generation model to improve the output quality of the visual generation model. In this way, global standardization may be replaced by intra-group relative advantage calculation, thereby improving the stability and scalability in human feedback learning.

In some embodiments, the electronic device 110 may determine the reward information corresponding to the respective pieces of visual content based on visual quality of the respective pieces of visual content. The video quality may be information related to image aesthetics or video aesthetics, etc. For example, for image aesthetics, a pre-trained model which is fine-tuned based on human rating data may be used to evaluate the video quality, and a ranking loss may be used to guide the training of the visual generation model, thereby generating images that better meet human aesthetics. For video aesthetics, video aesthetics extends image aesthetics to the time domain, and uses a visual language model to evaluate frame-level quality and frame-to-frame coherence.

In some embodiments, the electronic device 110 may determine a set of semantic information of a set of images, and then determine reward information corresponding to the set of images based on a comparison between the set of semantic information and reference semantic information corresponding to the input information. For example, the visual generation model may determine a set of semantic information corresponding to the set of images, and then determine whether the generated image content is consistent with the input information at the semantic level based on the comparison between the set of semantic information and the reference semantic information corresponding to the input information. The reward information corresponding to the set of images is determined based on the consistency between the two. In this way, the generated images may semantically fit to the content of the input information, thereby reducing the deviation between text and images.

In some embodiments, the electronic device 110 may use a visual language model to generate motion evaluation information of a set of videos, and then determine reward information corresponding to the set of videos based on the motion evaluation information. For example, motion realism and temporal consistency may be evaluated by a visual language model which is fine-tuned based on a manual rating dataset. The visual language model is used to analyze motion trajectories, object deformation patterns, and transition effects that conform to physical laws, to identify and reduce the influence of distortion artifacts, while enhancing the effect of natural motion synthesis.

In some embodiments, the electronic device 110 may determine an evaluation result corresponding to the respective pieces of visual content; and determine, based on a comparison between the evaluation result and a threshold, the reward information corresponding to the respective pieces of visual content as a first preset value or a second preset value. For example, the visual generation model may be designed as a binary reward model. Specifically, a threshold may be set, a value exceeding the threshold may be given a first preset reward value (for example, 1), and a value not exceeding the threshold may be given a second reward value (for example, 0).

Continuing to refer to FIG. 2, at block 230, the electronic device 110 may determine advantage information of the respective pieces of visual content in the set of visual content based on the reward information corresponding to the respective pieces of visual content.

Using FIG. 3 as an example, a group computing unit 307 may determine a reward mean value mean ({r₁, r₂, . . . , r_{G}}) and a reward variance std ({r₁, r₂, . . . , r_{G}}) based on a set of reward information {r₁, r₂, . . . , r_{G}} corresponding to the set of visual content {o₁, o₂, . . . , o_{G}}. Further, the group computing unit 307 may determine advantage information Aᵢ 308 corresponding to the respective pieces of visual content based on the reward information corresponding to the respective pieces of visual content, the reward mean value, and the reward variance. Specifically, the advantage information is positively correlated with a difference between the reward information and the reward mean value, and the advantage information is inversely proportional to the reward variance. As an example, the process of determining the advantage information Aᵢ 308 may be expressed as:

$${A}_{i} = \frac{{r}_{i} - mean ( \{ {r}_{1} , {r}_{2} , … , {r}_{G} \} )}{std ( \{ {r}_{1} , {r}_{2} , … , {r}_{G} \} )}$$

Continuing to refer to FIG. 2, at block 240, the electronic device 110 may adjust the visual generation model at least based on a set of advantage information corresponding to the set of visual content.

In some embodiments, the electronic device 110 may determine a target function based on the set of advantage information Aᵢ 308, and then adjust the visual generation model by maximizing a value of the target function. For example, the input information may be expressed as c, and the generated set of visual content may be expressed as {o₁, o₂, . . . , o_{G}}. Then, the formula of the target function may be as follows:

$${J}_{G RPO} ( θ ) = {E}_{\begin{matrix}{\{ {o}_{i} \}}_{i = 1}^{G} ∼ {π}_{{θ}_{old} ( \cdot \vert c )} \\ {a}_{t , i} ∼ {π}_{old} ( \cdot \vert {s}_{t , i} )\end{matrix}} [ \frac{1}{G T} {\sum }_{i = 1}^{G} {\sum }_{t = 1}^{T} min ( {r}_{t , i} {A}_{i} , clip ( {r}_{t , i} , 1 - ε , 1 + ε ) {A}_{i} ) ]$$

where r_{t,i} represents a sampling weight, Aᵢ represents the advantage information, ε is a hyperparameter, and π_{θ}(a_{t,i}|s_{t,i}) is a policy function for an output oᵢ at a time step t. The visual generation model may be optimized by maximizing the target function.

In some embodiments, the electronic device 110 may determine a plurality of sampling weights of the respective pieces of visual content at a plurality of denoising time steps, and then determine the target function based on the plurality of sampling weights and the advantage information corresponding to the respective pieces of visual content.

In some embodiments, the electronic device 110 may determine, based on a second group of parameters of the visual generation model, a second probability of performing the state transition action at the target denoising time step. The second group of parameters is determined by adjusting the visual generation model. Then, the sampling weight at the target denoising time step is determined based on a comparison between the first probability and the second probability. For example, the calculation formula for the sampling weight r_{t,i} may be as follows:

$${r}_{t , i} = \frac{{π}_{θ} ( {a}_{t , i} \vert {s}_{t , i} )}{{π}_{{θ}_{o l d}} ( {a}_{t , i} \vert {s}_{t , i} )} ∘$$

where r_{t,i} is a ratio of a new policy to an old policy, a first group of parameters of the visual generation model is π_{θ}_{_{old}}, a second group of parameters of the visual generation model is π_{θ}, the state transition action is a_{t,i}, the first probability is π_{θ}_{_{old}}(a_{t,i}|s_{t,i}), and the second probability is π_{θ}(a_{t,i}|s_{t,i}).

In an embodiment, in reinforcement learning, if an agent only receives rewards at a few time steps, but no rewards at most time steps, it is called reward sparsity. Due to the existence of reward sparsity in practice, the same reward may be adopted for all time steps in the optimization process, thereby helping the agent learn more stably through reward densification. KL regularization is used to constrain the difference between the new policy and the old policy to prevent policy mutations caused by excessive optimization rewards. However, omitting KL regularization has little impact on model performance and KL regularization increases computational complexity. Therefore, the embodiments of the present disclosure may remove the KL regularization term.

In some scenarios, the visual generation model 302 may include a diffusion model and a rectified flow. Specifically, the denoising process of the visual generation model 302 may be expressed as a Markov decision process. The process may be expressed by a formular as follows:

$${s}_{t} {=}^{Δ} ( c , t , {z}_{t} ) , π ( {a}_{t} \vert {s}_{t} ) {=}^{Δ} p ( {z}_{t - 1} \vert {z}_{t} , c ) , P ( {s}_{t + 1} \vert {s}_{t} , {a}_{t} ) {=}^{Δ} ( {δ}_{c} , {δ}_{t - 1} , {δ}_{{z}_{t - 1}} )$$

$${a}_{t} {=}^{Δ} {z}_{t - 1} , R ( {s}_{t} , {a}_{t} ) {=}^{Δ} \{ \begin{matrix}r ( {z}_{0} , c ) , & if t = 0 \\ 0 , & otherwise\end{matrix} , {p}_{0} ( {s}_{0} ) {=}^{Δ} ( p ( c ) , {δ}_{T} , N ( 0 , I ) )$$

where c is the prompt information, π(aₜ|sₜ) represents the probability of state transition caused by performing the action aₜ in a state sₜ, and δ_{y} is the Dirac δ distribution with non-zero density at y. The diffusion process consists of T time steps, and after the diffusion process ends, the policy P will lead to an absorbing state. r(x,c) represents the reward model.

In some embodiments, π(aₜ|sₜ) may be derived through the process described below. First, the sampling process of the diffusion model and the rectified flow may be reconstructed as a stochastic differential equation, thereby eliminating the conflict between the ODE mechanism and the Markov decision framework, so that reinforcement learning may be applied to the visual generation model.

During the diffusion process, the diffusion model gradually destroys the observed data points by mixing the data with noise. The forward process of the diffusion model may correspond to the following formula:

zₜ=αₜX+σₜε

where ε~N(0,1). aₜ and σₜ represent noise schedules. Through the noise schedule, z₀ may be close to the original clean data, and z₁ is close to Gaussian noise. In order to generate new samples, initialization may be started from the sample z₁, and the sampling process of the diffusion model is determined based on the output \hat{ε}ₜ of the denoising model at the time step t. The formula is as follows:

zₛ=αₛ\hat{x}ₜ+σₛ\hat{ε}ₜ

The core objective of the rectified flow is to learn the probability distribution of data. The basic principle is to gradually transform a simple and easy-to-sample initial distribution into a complex target data distribution through a series of reversible transformations. For example, in the rectified flow, the forward process may be regarded as linear interpolation between the data x and a noise term, and the formula is as follows:

zₜ=(1−t)x+tε

ε represents Gaussian noise, and u=ε−x may be defined as a velocity field or a vector field. The diffusion model is similar, where ûₜ is the output of the denoising model at the time step t, and a lower noise level may be achieved through the following formula:

zₛ=zₜ+ûₜ·(s−t)

Although the diffusion model and the rectified flow have different theoretical foundations, they may both be expressed as:

\hat{z}ₛ=\hat{z}ₜ++Network output·(ηₛ−ηₜ)

For the ε-prediction of the diffusion model, it corresponds to \tilde{z}ₜ=zₜ/σₜ, ηₜ=αₜ/σₜ. For the rectified flow, \tilde{z}ₜ=zₜ, ηₜ=t are defined.

Since the output of the diffusion model is not discretized, it is necessary to discretize it in order to apply the group relative policy optimization method. The forward stochastic differential equation of the diffusion model may be dzₜ=fₜzₜdt+gₜdz, and the reverse process is as follows:

$$d {z}_{t} = ( {f}_{t} {z}_{t} - \frac{1 + {ε}_{t}^{2}}{2} {g}_{t}^{2} ∇ log {p}_{t} ( {z}_{t} ) ) d t + {ε}_{t} {g}_{t} d z$$

Similarly, the forward stochastic differential equation of the rectified flow may be dzₜ=uₜdt, which may be solved by the following stochastic differential equation:

$$d {z}_{t} = ( {u}_{t} - \frac{1}{2} {ε}_{t}^{2} ∇ log {p}_{t} ( {z}_{t} ) ) d t + {ε}_{t} d z$$

εₜ introduces randomness into the sampling process.

Therefore, the probability π(aₜ|sₜ) may be solved through the above two differential equations, thereby discretizing the output of the diffusion model to support the solution of the target function defined in the present disclosure.

### Example Apparatus and Device

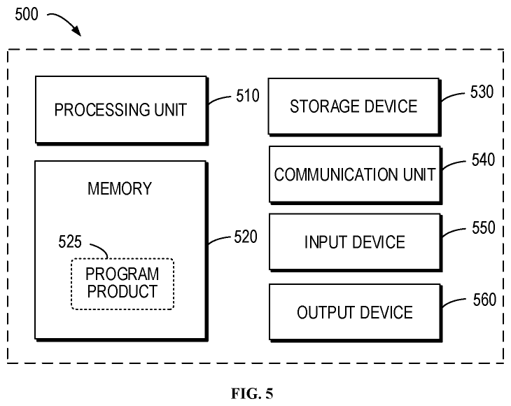

The embodiments of the present disclosure further provide corresponding apparatus for implementing the above methods or processes. FIG. 4 illustrates a schematic structural block diagram of an example apparatus 400 for information processing according to some embodiments of the present disclosure. The apparatus 400 may be implemented as or included in the electronic device 110. Each module/component in the apparatus 400 may be implemented by hardware, software, firmware, or any combination thereof.

As shown in FIG. 4, the apparatus 400 includes: an obtaining module 410 configured to obtain a set of visual content generated by a visual generation model based on input information; a first determination module 420 configured to determine reward information corresponding to respective pieces of visual content in the set of visual content; a second determination module 430 configured to determine advantage information of the respective pieces of visual content in the set of visual content based on the reward information corresponding to the respective pieces of visual content; and an adjustment module 440 configured to adjust the visual generation model at least based on a set of advantage information corresponding to the set of visual content.

In some embodiments, the first determination module 420 is configured to determine the reward information corresponding to the respective pieces of visual content based on visual quality of the respective pieces of visual content.

In some embodiments, the first determination module 420 is configured to determine a set of semantic information of a set of images; and determine reward information corresponding to the set of images based on a comparison between the set of semantic information and reference semantic information corresponding to the input information.

In some embodiments, the first determination module 420 is configured to generate motion evaluation information of the set of videos using a visual language model; and determine reward information corresponding to the set of videos based on the motion evaluation information.

In some embodiments, the first determination module 420 is configured to determine an evaluation result corresponding to the respective pieces of visual content; and determine, based on a comparison between the evaluation result and a threshold, the reward information corresponding to the respective pieces of visual content as a first preset value or a second preset value.

In some embodiments, the second determination module 430 is configured to determine a set of reward information corresponding to the set of visual content, and determine a reward mean value and a reward variance; and determine the advantage information corresponding to the respective pieces of visual content based on the reward information corresponding to the respective pieces of visual content, the reward mean value, and the reward variance.

In some embodiments, the advantage information is positively correlated with a difference between the reward information and the reward mean value, and the advantage information is inversely proportional to the reward variance.

In some embodiments, the adjustment module 440 is configured to determine a target function based on the set of advantage information; and adjust the visual generation model by maximizing a value of the target function.

In some embodiments, the adjustment module 440 is configured to determine a plurality of sampling weights of the respective pieces of visual content at a plurality of denoising time steps; and determine the target function based on the plurality of sampling weights and the advantage information corresponding to the respective pieces of visual content.

In some embodiments, the adjustment module 440 is configured to determine, based on a first group of parameters of the visual generation model, a first probability of performing, at a target denoising time step, a state transition action corresponding to generation of the corresponding visual content; determine, based on a second group of parameters of the visual generation model, a second probability of performing the state transition action at the target denoising time step, the second group of parameters being determined by adjusting the visual generation model; and determine a sampling weight at the target denoising time step based on a comparison between the first probability and the second probability.

FIG. 5 illustrates a block diagram of an electronic device 500 in which one or more embodiments of the present disclosure may be implemented. It should be understood that the electronic device 500 shown in FIG. 5 is only an example, without suggesting any limitations on the functions and scope of the embodiments described herein. The electronic device 500 shown in FIG. 5 may be configured to implement the electronic device 110 in FIG. 1.

As shown in FIG. 5, the electronic device 500 is in the form of a general-purpose electronic device. The components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor, and may perform various processing based on the programs stored in the memory 520. In a multi-processor system, a plurality of processing units execute computer executable instructions in parallel, to improve the parallel processing capability of the electronic device 500.

The electronic device 500 typically includes a plurality of computer storage medium. Such medium may be any available medium accessible to the electronic device 500, including, but not limited to, volatile and non-volatile medium, and removable and non-removable medium. The memory 520 may be a volatile memory (for example, a register, cache, a random access memory (RAM)), a non-volatile memory (such as a read-only memory (ROM), an electrically erasable programmable read-only memory (EEPROM), a flash memory), or any combination thereof. The storage device 530 may be any removable or non-removable medium, and may include a machine-readable medium, such as a flash drive, a disk, or any other medium, which may be used to store information and/or data and may be accessed within the electronic device 500.

The electronic device 500 may further include additional removable/non-removable, volatile/non-volatile memory medium. Although not shown in FIG. 5, a disk drive for reading from or writing into removable and non-volatile disks (such as a “floppy disk”), and an optical disk drive for reading from or writing into removable and non-volatile optical disks may be provided. In these cases, each drive may be connected to a bus (not shown) by one or more data medium interfaces. The memory 520 may include a computer program product 525, which has one or more program modules configured to perform various methods or actions in the embodiments of the present disclosure.

The communication unit 540 implements communication with another electronic device through a communication medium. In addition, the functions of the components of the electronic device 500 may be implemented by a single computing cluster or a plurality of computing machines, which may communicate through a communication connection. Therefore, the electronic device 500 may use a logical connection with one or more other servers, a network personal computer (PC), or another network node to operate in a networked environment.

The input device 550 may be one or more input devices, such as a mouse, a keyboard, a tracking ball, etc. The output device 560 may be one or more output devices, such as a display, a speaker, a printer, etc. The electronic device 500 may further communicate with one or more external devices (not shown) through the communication unit 540 as needed, the external devices being such as a storage device, a display device, etc., communicate with one or more devices that enable the user to interact with the electronic device 500, or communicate with any devices (such as a network card, a modem, etc.) that enable the electronic device 500 to communicate with one or more other electronic devices. Such communication may be performed via input/output (I/O) interfaces (not shown).

According to an example implementation of the present disclosure, there is provided a computer-readable storage medium having computer executable instructions stored thereon, where the computer executable instructions are executed by a processor to implement the method described above. According to an example implementation of the present disclosure, there is further provided a computer program product tangibly stored on a non-transitory computer-readable medium and including computer executable instructions, where the computer executable instructions are executed by a processor to implement the method described above.

Various aspects of the present disclosure are described herein with reference to the flowcharts and/or block diagrams of the method, the apparatus, the device, and the computer program product implemented according to the present disclosure. It should be understood that each block in the flowchart and/or block diagrams, and a combination of respective blocks in the flowchart and/or block diagrams may be implemented by computer-readable program instructions.

These computer-readable program instructions may be provided to a processing unit of a general-purpose computer, a special-purpose computer, or another programmable data processing apparatus to produce a machine, such that when the instructions are executed by the processing unit of the computer or another programmable data processing apparatus, an apparatus for implementing the functions/actions specified in one or more blocks in the flowcharts and/or block diagrams is produced. These computer-readable program instructions may also be stored in a computer-readable storage medium, and the instructions cause a computer, a programmable data processing apparatus, and/or another device to work in a specific manner, such that the computer-readable medium storing the instructions includes a manufactured product, which includes instructions for implementing various aspects of the functions/actions specified in one or more blocks in the flowcharts and/or block diagrams.

The computer-readable program instructions may be loaded onto a computer, another programmable data processing apparatus, or another device, such that a series of operations and steps are performed on the computer, the another programmable data processing apparatus, or the another device, to generate a computer-implemented process, so that the instructions executed on the computer, the another programmable data processing apparatus, or the another device implement the functions/actions specified in one or more blocks in the flowcharts and/or block diagrams.

The flowcharts and block diagrams in the drawings show the possibly implemented architectures, functions, and operations of the system, the method, and the computer program product according to a plurality of implementations of the present disclosure. In this regard, each block in the flowcharts or block diagrams may represent a module, program segment, or part of instructions, and the module, program segment, or part of instructions contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagrams and/or flowcharts, and a combination of blocks in the block diagrams and/or flowcharts may be implemented by a special-purpose hardware-based system that executes specified functions or actions, or may be implemented by a combination of special-purpose hardware and computer instructions.

The implementations of the present disclosure have been described above, and the above descriptions are examples, not exhaustive, and is not limited to the disclosed implementations. Many modifications and variations will be apparent to those of ordinary skill in the art without departing from the scope and spirit of the illustrated implementations. The terms used herein are selected to best explain the principles of the implementations, the practical applications, or the improvements to the technologies in the market, or to enable other those of ordinary skill in the art to understand the implementations disclosed herein.

1. A method of information processing, comprising:
obtaining a set of visual content generated by a visual generation model based on input information;
determining reward information corresponding to respective pieces of visual content in the set of visual content;
determining advantage information of the respective pieces of visual content in the set of visual content based on the reward information corresponding to the respective pieces of visual content; and
adjusting the visual generation model at least based on a set of advantage information corresponding to the set of visual content.

2. The method of claim 1, wherein determining the reward information corresponding to the respective pieces of visual content in the set of visual content comprises:
determining the reward information corresponding to the respective pieces of visual content based on visual quality of the respective pieces of visual content.

3. The method of claim 1, wherein the set of visual content comprises a set of images, and determining the reward information corresponding to the respective pieces of visual content in the set of visual content comprises:
determining a set of semantic information of the set of images; and
determining the reward information corresponding to the set of images based on a comparison between the set of semantic information and reference semantic information corresponding to the input information.

4. The method of claim 1, wherein the set of visual content comprises a set of videos, and determining the reward information corresponding to the respective pieces of visual content in the set of visual content comprises:
generating motion evaluation information of the set of videos using a visual language model; and
determining the reward information corresponding to the set of videos based on the motion evaluation information.

5. The method of claim 1, wherein determining the reward information corresponding to the respective pieces of visual content in the set of visual content comprises:
determining an evaluation result corresponding to the respective pieces of visual content; and
determining, based on a comparison between the evaluation result and a threshold, the reward information corresponding to the respective pieces of visual content as a first preset value or a second preset value.

6. The method of claim 1, wherein determining the advantage information of the respective pieces of visual content in the set of visual content based on the reward information corresponding to the respective pieces of visual content comprises:
determining a set of reward information corresponding to the set of visual content, and determining a reward mean value and a reward variance; and
determining the advantage information corresponding to the respective pieces of visual content based on the reward information corresponding to the respective pieces of visual content, the reward mean value, and the reward variance.

7. The method of claim 6, wherein the advantage information is positively correlated with a difference between the reward information and the reward mean value, and the advantage information is inversely proportional to the reward variance.

8. The method of claim 1, wherein adjusting the visual generation model at least based on the set of advantage information corresponding to the set of visual content comprises:
determining a target function based on the set of advantage information; and
adjusting the visual generation model by maximizing a value of the target function.

9. The method of claim 8, wherein determining the target function based on the set of advantage information comprises:
determining a plurality of sampling weights of the respective pieces of visual content at a plurality of denoising time steps; and
determining the target function based on the plurality of sampling weights and the advantage information corresponding to the respective pieces of visual content.

10. The method of claim 9, wherein determining the plurality of sampling weights of the respective piece of visual content at the plurality of denoising time steps comprises:
determining, based on a first group of parameters of the visual generation model, a first probability of performing, at a target denoising time step, a state transition action corresponding to generation of the corresponding visual content;
determining, based on a second group of parameters of the visual generation model, a second probability of performing the state transition action at the target denoising time step, the second group of parameters being determined by adjusting the visual generation model; and
determining a sampling weight at the target denoising time step based on a comparison between the first probability and the second probability.

11. An electronic device, comprising:
at least one processor; and
at least one memory coupled to the at least one processor and storing instructions executable by the at least one processor, the instructions, when executed by the at least one processor, causing the electronic device to perform operations comprising:
obtaining a set of visual content generated by a visual generation model based on input information;
determining reward information corresponding to respective pieces of visual content in the set of visual content;
determining advantage information of the respective pieces of visual content in the set of visual content based on the reward information corresponding to the respective pieces of visual content; and
adjusting the visual generation model at least based on a set of advantage information corresponding to the set of visual content.

12. The electronic device of claim 11, wherein determining the reward information corresponding to the respective pieces of visual content in the set of visual content comprises:
determining the reward information corresponding to the respective pieces of visual content based on visual quality of the respective pieces of visual content.

13. The electronic device of claim 11, wherein the set of visual content comprises a set of images, and determining the reward information corresponding to the respective pieces of visual content in the set of visual content comprises:
determining a set of semantic information of the set of images; and
determining the reward information corresponding to the set of images based on a comparison between the set of semantic information and reference semantic information corresponding to the input information.

14. The electronic device of claim 11, wherein the set of visual content comprises a set of videos, and determining the reward information corresponding to the respective pieces of visual content in the set of visual content comprises:
generating motion evaluation information of the set of videos using a visual language model; and
determining the reward information corresponding to the set of videos based on the motion evaluation information.

15. The electronic device of claim 11, wherein determining the reward information corresponding to the respective pieces of visual content in the set of visual content comprises:
determining an evaluation result corresponding to the respective pieces of visual content; and
determining, based on a comparison between the evaluation result and a threshold, the reward information corresponding to the respective pieces of visual content as a first preset value or a second preset value.

16. The electronic device of claim 11, wherein determining the advantage information of the respective pieces of visual content in the set of visual content based on the reward information corresponding to the respective pieces of visual content comprises:
determining a set of reward information corresponding to the set of visual content, and determining a reward mean value and a reward variance; and
determining the advantage information corresponding to the respective pieces of visual content based on the reward information corresponding to the respective pieces of visual content, the reward mean value, and the reward variance.

17. The electronic device of claim 16, wherein the advantage information is positively correlated with a difference between the reward information and the reward mean value, and the advantage information is inversely proportional to the reward variance.

18. The electronic device of claim 11, wherein adjusting the visual generation model at least based on the set of advantage information corresponding to the set of visual content comprises:
determining a target function based on the set of advantage information; and
adjusting the visual generation model by maximizing a value of the target function.

19. The electronic device of claim 18, wherein determining the target function based on the set of advantage information comprises:
determining a plurality of sampling weights of the respective pieces of visual content at a plurality of denoising time steps; and
determining the target function based on the plurality of sampling weights and the advantage information corresponding to the respective pieces of visual content.

20. A non-transitory computer-readable storage medium having a computer program stored thereon, the computer program being executable by a processor to implement operations comprising:
obtaining a set of visual content generated by a visual generation model based on input information;
determining reward information corresponding to respective pieces of visual content in the set of visual content;
determining advantage information of the respective pieces of visual content in the set of visual content based on the reward information corresponding to the respective pieces of visual content; and
adjusting the visual generation model at least based on a set of advantage information corresponding to the set of visual content.
